(19) United States
(12) Patent Application Publication
(10) Pub. No.: US 2018/0114071 A1
(43) Pub. Date: Apr. 26, 2018

(54) METHOD FOR ANALYSING MEDIA CONTENT

(71) Applicant: Nokia Technologies Oy, Espoo (FI)

(72) Inventor: Tinghuai WANG, Tampere (FI)

(21) Appl. No.: 15/785,711

(22) Filed: Oct. 17, 2017

(30) Foreign Application Priority Data
Oct. 21, 2016 (GB) 1617798.2

(51) Int. Cl. G06K 9/00; G06K 9/62; G06T 3/40; G06N 3/04; G06N 3/08

(52) U.S. Cl. CPC G06K 9/00765; G06K 9/6256; G06K 9/00744; G06K 9/6267; G06N 3/04; G06N 3/08; G06T 3/40

(57) ABSTRACT

The invention relates to a method, an apparatus and a computer program product for analyzing media content. The method comprises receiving media content objects by a feature extractor for extracting a plurality of feature maps from said media content objects; processing the plurality of feature maps in a bidirectional Long-Short Term memory neural network, where the bidirectional Long-Short Term memory neural network is aligned along different directions of the feature maps to produce low resolution feature maps; upsampling the low resolution feature maps to the size of received media content; and assigning each pixel of the upsampled feature maps with a label of maximum likelihood for segmenting objects from the upsampled feature maps.

### TECHNICAL FIELD

The present solution relates to computer vision and machine learning, and particularly to a method for analyzing media content.

### BACKGROUND

Many practical applications rely on the availability of semantic information about the content of the media, such as images, videos, etc. Semantic information is represented by metadata which may express the type of scene, the occurrence of a specific action/activity, the presence of a specific object, etc. Such semantic information can be obtained by analyzing the media.

The analysis of media is a fundamental problem which has not yet been completely solved. This is especially true when considering the extraction of high-level semantics, such as object detection and recognition, scene classification (e.g., sport type classification) action/activity recognition, etc.

Recently, the development of various neural network techniques has enabled learning to recognize image content directly from the raw image data, whereas previous techniques consisted of learning to recognize image content by comparing the content against manually trained image features. Very recently, neural networks have been adapted to take advantage of visual spatial attention, i.e. the manner how humans conceive a new environment by focusing first to a limited spatial region of the scene for a short moment and then repeating this for a few more spatial regions in the scene in order to obtain an understanding of the semantics in the scene.

Although the deep neural architecture have been very successful in many high-level tasks such as image recognition and object detection, achieving semantic video segmentation which is large scale pixel-level classification or labelling is still challenging. There are several reasons. Firstly, the popular convolutional neural network (CNN) architectures utilize local information rather than global context for prediction, due to the use of convolutional kernels. Secondly, existing deep architectures are predominantly centered on modelling the image data, whilst how to perform end-to-end modeling and prediction of video data using deep neural networks for pixel labelling problem is still unknown.

### SUMMARY

Now there has been invented an improved method and technical equipment implementing the method, by which the above problems are alleviated. Various aspects of the invention include a method, an apparatus, and a computer readable medium comprising a computer program stored therein, which are characterized by what is stated in the independent claims. Various embodiments of the invention are disclosed in the dependent claims.

According to a first aspect, there is provided a method comprising receiving media content objects by a feature extractor for extracting a plurality of feature maps from said media content objects; processing the plurality of feature maps in a bidirectional Long-Short Term memory neural network, where the bidirectional Long-Short Term memory neural network is aligned along different directions of the feature maps to produce low resolution feature maps; upsampling the low resolution feature maps to the size of received media content; and assigning each pixel of the upsampled feature maps with a label of maximum likelihood for segmenting objects from the ups ampled feature maps.

According to a second aspect, there is provided an apparatus comprising at least one processor, memory including computer program code, the memory and the computer program code configured to, with the at least one processor, cause the apparatus to perform at least the following: receive media content objects by a feature extractor for extracting a plurality of feature maps from said media content objects; process the plurality of feature maps in a bidirectional Long-Short Term memory neural network, where the bidirectional Long-Short Term memory neural network is aligned along different directions of the deep feature maps to produce low resolution feature maps; upsample the low resolution feature maps to the size of received media content; and assign each pixel of the ups ampled feature maps with a label of maximum likelihood for segmenting objects from the upsampled feature maps.

According to a third aspect, there is provided an apparatus comprising means for receiving media content objects by a feature extractor for extracting a plurality of feature maps from said media content objects; means for processing the plurality of feature maps in a bidirectional Long-Short Term memory neural network, where the bidirectional Long-Short Term memory neural network is aligned along different directions of the deep feature maps to produce low resolution feature maps; means for upsampling the low resolution feature maps to the size of received media content; and means for assigning each pixel of the upsampled feature maps with a label of maximum likelihood for segmenting objects from the upsampled feature maps.

According to a fourth aspect, there is provided computer program product embodied on a non-transitory computer readable medium, comprising computer program code configured to, when executed on at least one processor, cause an apparatus or a system to: receive media content objects by a feature extractor for extracting a plurality of feature maps from said media content objects; process the plurality of feature maps in a bidirectional Long-Short Term memory neural network, where the bidirectional Long-Short Term memory neural network is aligned along different directions of the deep feature maps to produce low resolution feature maps; upsample the low resolution feature maps to the size of received media content; and assign each pixel of the upsampled feature maps with a label of maximum likelihood for segmenting objects from the ups ampled feature maps.

According to an embodiment, the media content comprises video frames.

According to an embodiment, the different directions of the feature maps comprise vertical, horizontal and temporal directions.

According to an embodiment, the processing in the bidirectional Long-Short Term memory neural network is repeated at least N times, where N is a positive integer.

According to an embodiment, the feature extractor is a Convolutional Neural Network (CNN).

### DESCRIPTION OF THE DRAWINGS

In the following, various embodiments of the invention will be described in more detail with reference to the appended drawings, in which

FIG. 1 shows a computer graphics system suitable to be used in a computer vision process according to an embodiment;

FIG. 2 shows an example of a Convolutional Neural Network typically used in computer vision systems;

FIG. 3 shows network architecture according to an embodiment;

FIG. 4 shows an example of a deep feature extraction on a video frame;

FIG. 5 shows an example of network architecture of spatial-temporal bidirectional LSTM;

FIG. 6 shows an example of a bidirectional LSTMs aligned with vertical grids;

FIG. 7 shows an example of bidirectional LSTMs aligned along horizontal grids;

FIG. 8 shows an example of bidirectional LSTMs aligned along temporal grids;

FIG. 9 shows an example of segmentation results on two frames from a video; and

FIG. 10 is a flowchart illustrating a method according to an embodiment.

### DESCRIPTION OF EXAMPLE EMBODIMENTS

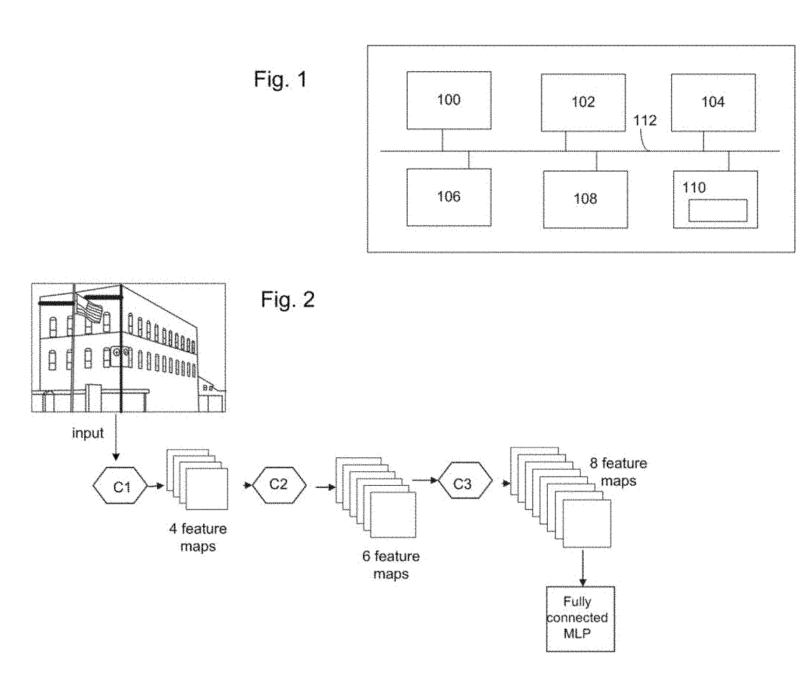

FIG. 1 shows a computer graphics system suitable to be used in image processing, for example in computer vision process according to an embodiment. The generalized structure of the computer graphics system will be explained in accordance with the functional blocks of the system. Several functionalities can be carried out with a single physical device, e.g. all calculation procedures can be performed in a single processor if desired. A data processing system of an apparatus according to an example of FIG. 1 comprises a main processing unit 100, a memory 102, a storage device 104, an input device 106, an output device 108, and a graphics subsystem 110, which are all connected to each other via a data bus 112.

The main processing unit 100 is a conventional processing unit arranged to process data within the data processing system. The memory 102, the storage device 104, the input device 106, and the output device 108 are conventional components as recognized by those skilled in the art. The memory 102 and storage device 104 store data within the data processing system 100. Computer program code resides in the memory 102 for implementing, for example, computer vision process. The input device 106 inputs data into the system while the output device 108 receives data from the data processing system and forwards the data, for example to a display. The data bus 112 is a conventional data bus and while shown as a single line it may be any combination of the following: a processor bus, a PCI bus, a graphical bus, an ISA bus. Accordingly, a skilled person readily recognizes that the apparatus may be any conventional data processing device, such as a computer device, a personal computer, a server computer, a mobile phone, a smart phone or an Internet access device, for example Internet tablet computer.

It needs to be understood that different embodiments allow different parts to be carried out in different elements. For example, various processes of the computer vision system may be carried out in one or more processing devices; for example, entirely in one computer device, or in one server device or across multiple user devices. The elements of computer vision process may be implemented as a software component residing on one device or distributed across several devices, as mentioned above, for example so that the devices form a so-called cloud.

The state-of-the-art approach for the analysis of data in general and of visual data in particular is deep learning. Deep learning is a sub-field of machine learning which has emerged in the recent years. Deep learning typically involves learning of multiple layers of nonlinear processing units, either in supervised or in unsupervised manner. These layers form a hierarchy of layers. Each learned layer extracts feature representations from the input data, where features from lower layers represent low-level semantics (i.e. more abstract concepts). Unsupervised learning applications typically include pattern analysis and supervised learning applications typically include classification of image objects.

Recent developments in deep learning techniques allow for recognizing and detecting objects in images or videos with great accuracy, outperforming previous methods. The fundamental difference of deep learning image recognition technique compared to previous methods is learning to recognize image objects directly from the raw data, whereas previous techniques are based on recognizing the image objects from hand-engineered features (e.g. SIFT features). During the training stage, deep learning techniques build hierarchical layers which extract features of increasingly abstract level.

Thus, an extractor or a feature extractor is commonly used in deep learning techniques. A typical example of a feature extractor in deep learning techniques is the Convolutional Neural Network (CNN), shown in FIG. 2. A CNN is composed of one or more convolutional layers with fully connected layers on top. CNNs are easier to train than other deep neural networks and have fewer parameters to be estimated. Therefore, CNNs have turned out to be a highly attractive architecture to use, especially in image and speech applications.

In FIG. 2, the input to a CNN is an image, but any other media content object, such as video file, could be used as well. Each layer of a CNN represents a certain abstraction (or semantic) level, and the CNN extracts multiple feature maps. The CNN in FIG. 2 has only three feature (or abstraction, or semantic) layers C1, C2, C3 for the sake of simplicity, but current top-performing CNNs may have over 20 feature layers.

The first convolution layer C1 of the CNN consists of extracting 4 feature-maps from the first layer (i.e. from the input image). These maps may represent low-level features found in the input image, such as edges and corners. The second convolution layer C2 of the CNN, consisting of extracting 6 feature-maps from the previous layer, increases the semantic level of extracted features. Similarly, the third convolution layer C3 may represent more abstract concepts found in images, such as combinations of edges and corners, shapes, etc. The last layer of the CNN (fully connected MLP) does not extract feature-maps. Instead, it usually consists of using the feature-maps from the last feature layer in order to predict (recognize) the object class. For example, it may predict that the object in the image is a house.

The present embodiments relate to semantic video segmentation using spatial-temporal bidirectional long-short term memory neural networks. Semantic video segmentation is about assigning each pixel in video with a known label. Currently, the semantic video segmentation is still an open challenge with recent advances relying upon prior knowledge supplied via pre-trained image or object recognition model. Fully automatic semantic video segmentation on the other hand remains useful in scenarios where the human in the loop is impractical, such as augmented reality, virtual reality, robotic vision, and surveillance.

Although the deep neural architectures have been very successful in many high-level tasks, such as image recognition and object detection, achieving semantic video segmentation which is large scale pixel-level classification or labelling is still challenging. There are several reasons. Firstly, the popular convolutional neural network (CNN) architectures utilize local information rather than global context for prediction, due to the use of convolutional kernels. Secondly, existing deep architectures are predominantly centered on modelling the image data, whilst how to perform end-to-end modelling and prediction of video data using deep neural networks for pixel labelling problem is still unknown.

These embodiments propose use of bidirectional Long-Short Term Memory (LSTM) neural network to model the semantic video segmentation problem, so that both the deep representation learning and semantic label inference can be jointly performed on the time series data. The embodiments integrate long range contextual dependencies in video data while avoiding post-processing methods used in existing methods for object delineation. Bidirectional LSTM uses LSTM units to replace vanilla RNN (Recurrent Neural Network) units, and thus is able to capture the very long term contextual dependencies by selecting relevant information.

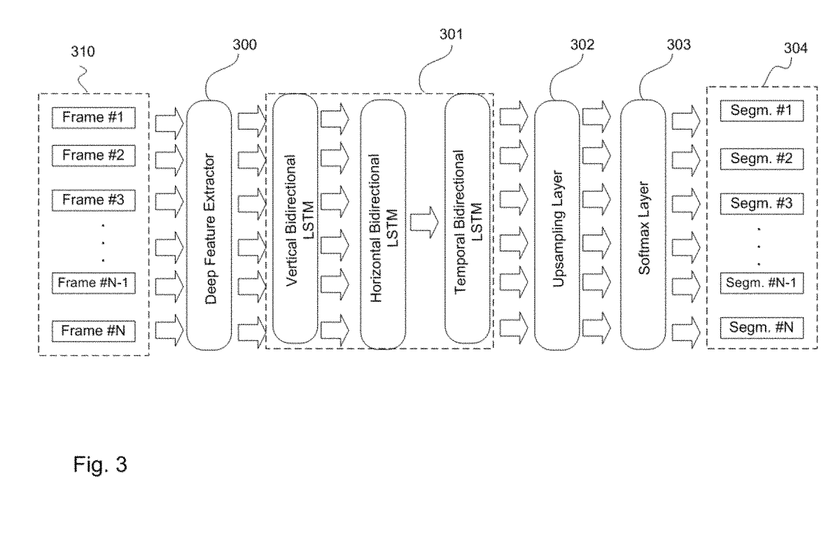

FIG. 3 illustrates network architecture according to an embodiment. The network comprises at least four components: 1) deep feature extraction; 2) vertical, horizontal and temporal bi-directional LSTMs; 3) upsampling layer; and 4) softmax layer. The module 301, i.e. spatial-temporal bi-directional LSTM can be repeated for multiple times, for example at least N times, where N is a positive integer, e.g. 1, 2, 3, etc. In the following, the four components, i.e. deep feature extractor 300, spatial-temporal bi-directional LSTM 301, an upsampling layer 302, and a softmax layer 303 are discussed in more detailed manner.

1) Deep Feature Extraction

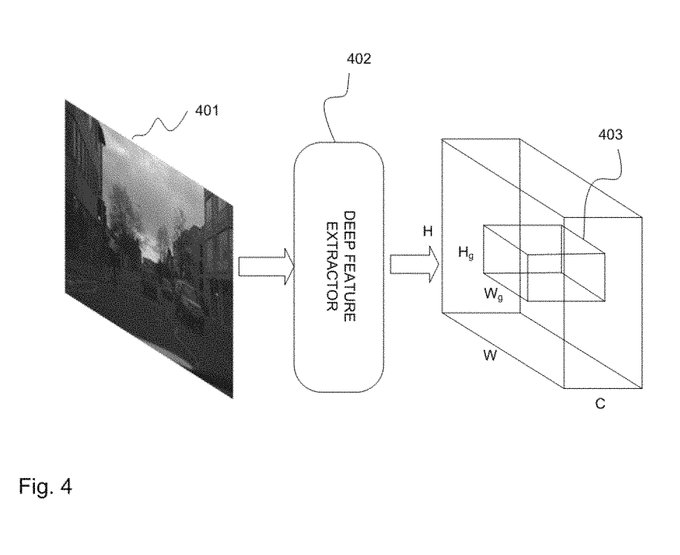

Deep feature extraction component 300 takes as an input a sequence of deep feature maps extracted from plurality of video frames 310. According to an embodiment, convolutional layers of existing pre-trained deep CNN architectures (e.g., Conv-5, Conv-6, Conv-7 of VGG-16 Net) for image recognition task can be utilized in deep feature extraction. The present solution is agnostic to the type of feature used. All feature maps may, at first, be divided into evenly distributed grids, resulting in I×J grids g_{i,j}ϵ R^{H}^{_{g,}}^{W}^{_{g,}}^{C}. FIG. 4 shows an example where deep feature extractor component 402 takes as an input a single video frame 401, and outputs a grid 403.

2) Spatial-Temporal Bidirectional LSTM

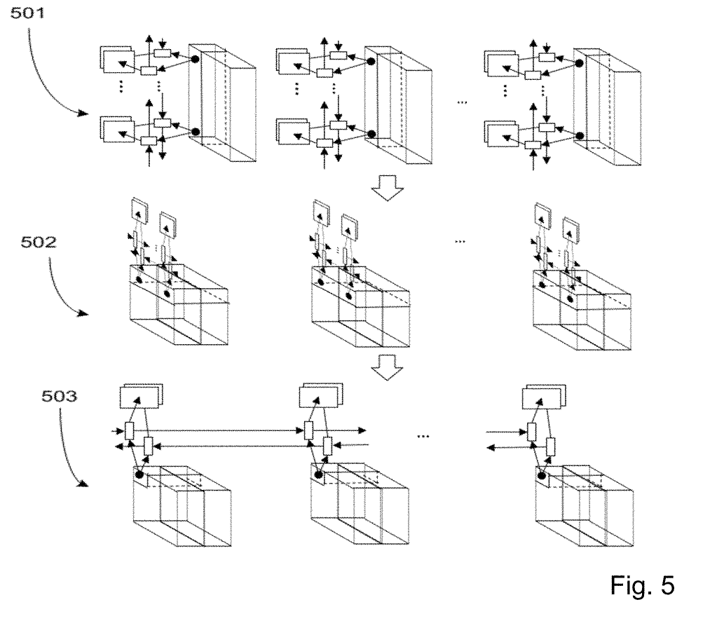

The spatial-temporal bidirectional LSTM module 301 (FIG. 3) comprises three bi-directional LSTM networks aligned along the vertical, horizontal and temporal directions of the input feature map respectively. This module is illustrated in more detailed manner in FIG. 5 showing vertical bidirectional LSTM 501, horizontal bidirectional LSTM 502 and temporal bidirectional LSTM 503.

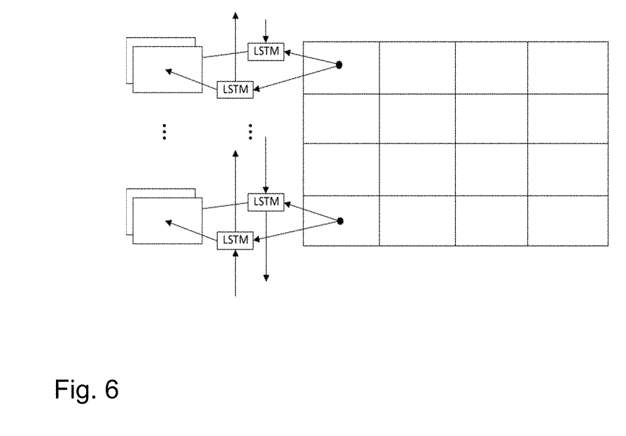

Given the feature map from feature extractor or previous spatial-temporal bidirectional LSTM module, the first bidirectional LSTM (i.e. the vertical bidirectional LSTM) 501 is aligned along each column of the feature map as illustrated in more detailed manner in FIG. 6, collecting the long term spatial dependencies vertically. The vertical bidirectional LSTM 501 takes as input each column from a H_{g}*W_{g}*C_{g} feature map, where C_{g} is the concatenated feature vector in each grid, and outputs hidden states of size H_{g}*C, where C is the number of hidden states per LSTM unit (H_{g} LSTM units in total). The hidden states of the LSTMs result in a new feature map which has the same resolution as the input, with a doubled third dimension R^{H}^{_{g,}}^{W}^{_{g,}}^{2C} due to stacking the bidirectional hidden states. As a result, by stacking the hidden states of vertical LSTMs from two vertical directions from all columns, the output would be H_{g}*W_{g}*2C.

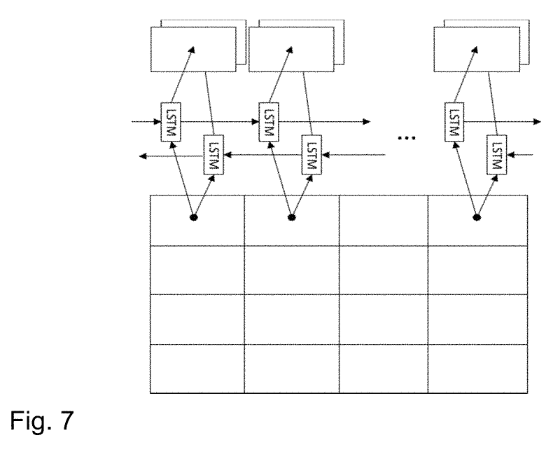

In a horizontal bidirectional LSTM 502 (FIG. 5) a bidirectional LSTM is aligned along each row of the feature map, i.e., the hidden states R^{H}^{_{g,}}^{W}^{_{g,}}^{2C} from the vertical LSTM. FIG. 7 illustrates the bidirectional LSTMs aligned along horizontal grids of resulted hidden states from vertical direction. The horizontal bidirectional LSTM takes H_{g}*W_{g}*2C feature map from previous layer. Each LSTM on one direction takes as input a row from the feature map, and outputs hidden states of dimensions W_{g}*C (W_{g} LSTM units in total, and each produces C hidden states). This network of FIG. 7 collects the global spatial contextual information from both vertical and horizontal direction, and outputs stacked hidden states with dimensions R^{H}^{_{g,}}^{W}^{_{g,}}^{2C}. After stacking the hidden states of both horizontal directions over all rows, the output would still be H_{g}*W_{g}*2C.

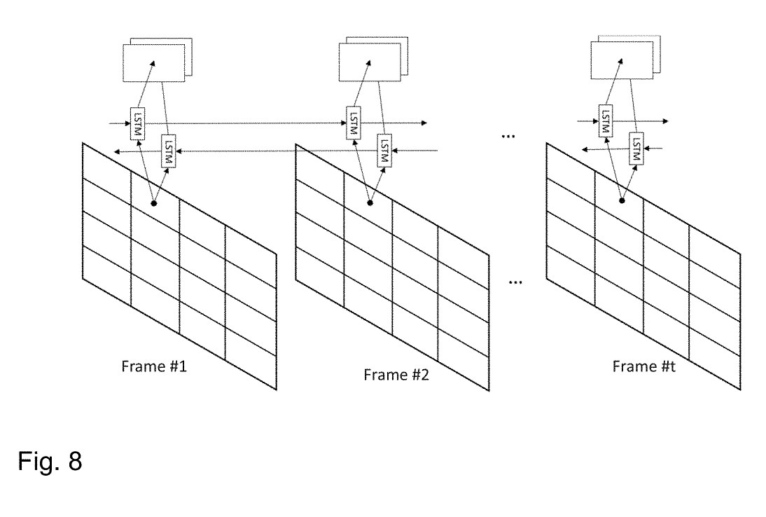

A third bidirectional LSTM, i.e. temporal bidirectional LSTM 503 (FIG. 5), is illustrated in more detailed in FIG. 8. The temporal bidirectional LSTM is configured along the temporal directions, connecting grids from consecutive frames on the same spatial location. The intuition is to exploit the temporally consistent semantic evidence on the same spatial location. The temporal LSTM, which is aligned along N temporal feature maps (N*H_{g}*W_{g}*2C) generated from previous LSTM layers, takes as input an N*2C feature vector in temporal direction, and outputs hidden states of length N*C (N LSTM units in total, and each produces C hidden states). Consequently, the output at each pixel/grid location, i.e. the hidden states from LSTM, implicitly encodes the global contextual information of the whole video. The stacked outputs from both temporal directions would be N*H_{g}*W_{g}*2C on consecutive frames.

It is to be noticed that the spatial-temporal bidirectional LSTM module has been described to contain three bi-directional LSTM networks, i.e. the vertical, horizontal and temporal. However, within the spatial-temporal bidirectional LSTM module, the order of the LSTM networks is not restricted to the example of FIG. 3. The processing order in the spatial-temporal bidirectional LSTM module may thus vary, and any order of the vertical, horizontal and temporal bidirectional LSTM networks is possible. Especially, locations of the horizontal and vertical bidirectional LSTM networks may be interchanged.

3) Upsampling Layer

Let us turn again to FIG. 3. The spatial-temporal bidirectional LSTM 301 is configured to outputs a feature map with the same resolution as the original feature map from CNN feature extraction module 300, which is smaller than the original video frame due to the pooling layers of CNNs. A bilinear upsampling layer 302 is added to upsample the low resolution feature map to the size of the original video frame. In another embodiment, a trainable upsampling layer can be used whose weights can be trained together with the spatial-temporal bidirectional LSTM component 301.

4) Softmax Layer

The last layer is a per-pixel softmax layer 303 for both label prediction and loss computation. For segmentation, each pixel is assigned with the label which gives the maximum likelihood

y_{pred}=argmaxᵢP(Y=i|x,W,b)

For training, the per-pixel loss is measured using negative log-likelihood from softmax,

$$ℒ ( θ = \{ W , b \} , D ) = {\sum }_{i = 0}^{\vert D \vert} log ( P ( Y = {y}^{( i )} \vert {x}^{( i )} , W , b ) )$$

$$𝓁 ( θ = \{ W , b \} , D ) = - ℒ ( θ = \{ W , b \} , D )$$

where W and b are the weights of softmax layer, L is the log-likelihood and l is the loss.

The softmax layer 303 outputs a segmentation result 304 comprising a plurality of segments.

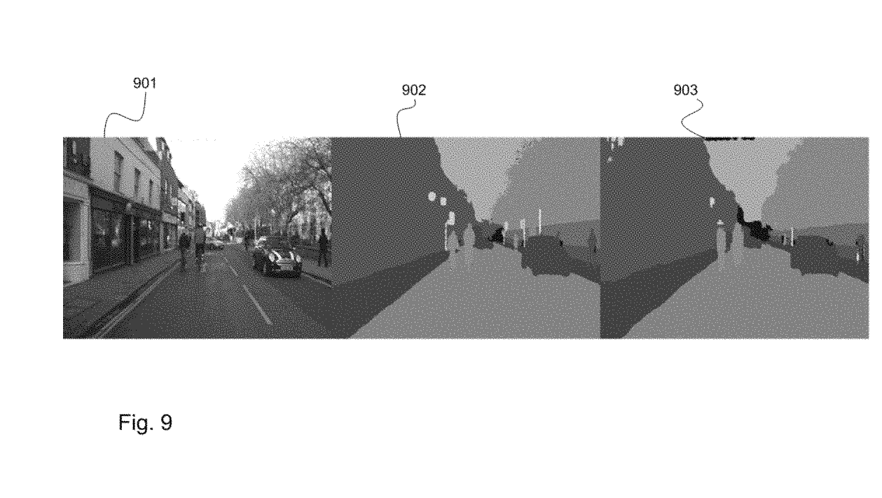

FIG. 9 illustrates an example of segmentation results on two frames from a video with semantic labels “sidewalk”, “building”, “road”, “car” and “trees”. Image 901 represents the source video frame, image 902 represents the ground-truth and image 903 represents the segmentation result.

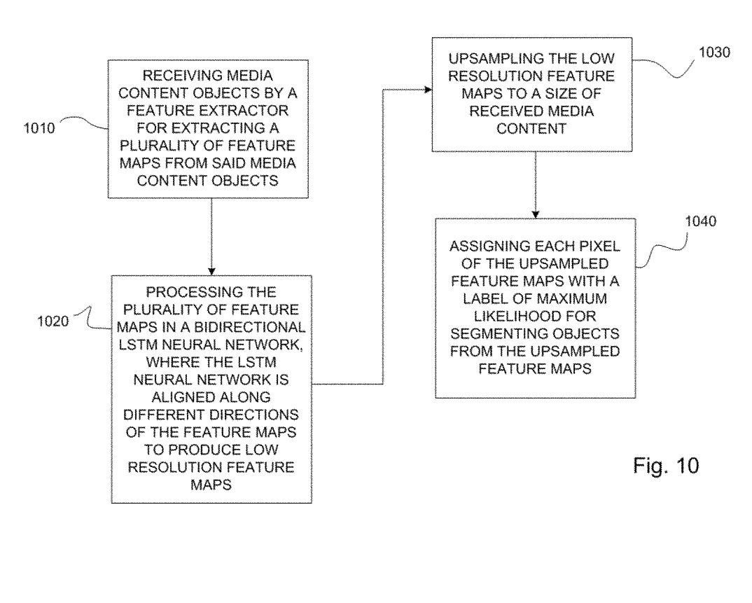

FIG. 10 is a flowchart illustrating a method according to an embodiment. A method comprises receiving media content objects by a feature extractor for extracting a plurality of feature maps from said media content objects; processing the plurality of feature maps in a bidirectional Long-Short Term memory neural network, where the bidirectional Long-Short Term memory neural network is aligned along different directions of the feature maps to produce low resolution feature maps; upsampling the low resolution feature maps to the size of received media content; and assigning each pixel of the upsampled feature maps with a label of maximum likelihood for segmenting objects from the upsampled feature maps.

An apparatus according to an embodiment comprises means for receiving media content objects by a feature extractor for extracting a plurality of feature maps from said media content objects; means for processing the plurality of feature maps in a bidirectional Long-Short Term memory neural network, where the bidirectional Long-Short Term memory neural network is aligned along different directions of the feature maps to produce low resolution feature maps; means for upsampling the low resolution feature maps to the size of received media content; and means for assigning each pixel of the upsampled feature maps with a label of maximum likelihood for segmenting objects from the upsampled feature maps. The means comprises a processor, a memory, and a computer program code residing in the memory.

In previous, embodiments for semantic video segmentation have been disclosed. The semantic video segmentation according to embodiments uses spatial-temporal bidirectional long-short term memory neural networks. The present embodiments do not require user interaction, but can work automatically. In addition, the present embodiments do not require any prior knowledge of the video to be segmented or of the label of the class.

The various embodiments may provide advantages. For example, existing image classifier may be used to achieve the challenging semantic video object segmentation problem, without the need of large-scale pixel level annotation and training.

The various embodiments of the invention can be implemented with the help of computer program code that resides in a memory and causes the relevant apparatuses to carry out the invention. For example, a device may comprise circuitry and electronics for handling, receiving and transmitting data, computer program code in a memory, and a processor that, when running the computer program code, causes the device to carry out the features of an embodiment. Yet further, a network device like a server may comprise circuitry and electronics for handling, receiving and transmitting data, computer program code in a memory, and a processor that, when running the computer program code, causes the network device to carry out the features of an embodiment.

If desired, the different functions discussed herein may be performed in a different order and/or concurrently with other. Furthermore, if desired, one or more of the above-described functions and embodiments may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments, these descriptions should not be viewed in a limiting sense. Rather, there are several variations and modifications, which may be made without departing from the scope of the present disclosure as, defined in the appended claims.

1. A method, comprising:
receiving media content objects by a feature extractor for extracting a plurality of feature maps from said media content objects;
processing the plurality of feature maps in a bidirectional Long-Short Term memory neural network, where the bidirectional Long-Short Term memory neural network is aligned along different directions of the feature maps to produce low resolution feature maps;
upsampling the low resolution feature maps to the size of received media content; and
assigning each pixel of the upsampled feature maps with a label of maximum likelihood for segmenting objects from the upsampled feature maps.

2. The method according to claim 1, wherein the media content comprises video frames.

3. The method according to claim 1, wherein the different directions of the feature maps comprise vertical, horizontal and temporal directions.

4. The method according to claim 1, further comprising repeating the processing in the bidirectional Long-Short Term memory neural network at least N times, where N is a positive integer.

5. The method according to claim 1, wherein the feature extractor is a Convolutional Neural Network (CNN).

6. An apparatus comprising at least one processor, memory including computer program code, the memory and the computer program code configured to, with the at least one processor, cause the apparatus to perform at least the following:
receive media content objects by a feature extractor for extracting a plurality of feature maps from said media content objects;
process the plurality of feature maps in a bidirectional Long-Short Term memory neural network, where the bidirectional Long-Short Term memory neural network is aligned along different directions of the deep feature maps to produce low resolution feature maps;
upsample the low resolution feature maps to the size of received media content; and
assign each pixel of the upsampled feature maps with a label of maximum likelihood for segmenting objects from the upsampled feature maps.

7. The apparatus according to claim 6, wherein the media content comprises video frames.

8. The apparatus according to claim 6, wherein the different directions of the feature maps comprise vertical, horizontal and temporal directions.

9. The apparatus according to claim 6, further comprising repeating the processing in the bidirectional Long-Short Term memory neural network at least N times, where N is a positive integer.

10. The apparatus according to claim 6, wherein the feature extractor is a Convolutional Neural Network (CNN).

11. An apparatus comprising:
means for receiving media content objects by a feature extractor for extracting a plurality of feature maps from said media content objects;
means for processing the plurality of feature maps in a bidirectional Long-Short Term memory neural network, where the bidirectional Long-Short Term memory neural network is aligned along different directions of the deep feature maps to produce low resolution feature maps;
means for upsampling the low resolution feature maps to the size of received media content; and
means for assigning each pixel of the upsampled feature maps with a label of maximum likelihood for segmenting objects from the upsampled feature maps.

12. The apparatus according to claim 11, wherein the media content comprises video frames.

13. The apparatus according to claim 11, wherein the different directions of the feature maps comprise vertical, horizontal and temporal directions.

14. The apparatus according to claim 11, further comprising means for repeating the processing in the bidirectional Long-Short Term memory neural network at least N times, where N is a positive integer.

15. The apparatus according to claim 11, wherein the feature extractor is a Convolutional Neural Network (CNN).

16. A computer program product embodied on a non-transitory computer readable medium, comprising computer program code configured to, when executed on at least one processor, cause an apparatus or a system to:
receive media content objects by a feature extractor for extracting a plurality of feature maps from said media content objects;
process the plurality of feature maps in a bidirectional Long-Short Term memory neural network, where the bidirectional Long-Short Term memory neural network is aligned along different directions of the deep feature maps to produce low resolution feature maps;
upsample the low resolution feature maps to the size of received media content; and
assign each pixel of the upsampled feature maps with a label of maximum likelihood for segmenting objects from the upsampled feature maps.

17. The computer program product according to claim 16, wherein the media content comprises video frames.

18. The computer program product according to claim 16, wherein the different directions of the feature maps comprise vertical, horizontal and temporal directions.

19. The computer program product according to claim 16, further comprising computer program code configured to cause an apparatus or a system to repeat the processing in the bidirectional Long-Short Term memory neural network at least N times, where N is a positive integer.

20. The computer program product according to claim 16, wherein the feature extractor is a Convolutional Neural Network (CNN).
